(19) United States
(12) Patent Application Publication
(10) Pub. No.: US 2006/0262153 A1
(43) Pub. Date: Nov. 23, 2006

(54) Droplet ejection apparatus, electro-optic panel, and electronic device

(76) Inventor: Osamu Kasuga, Suwa-shi (JP)

Correspondence Address: HARNESS, DICKEY & PIERCE, P.L.C., P.O. BOX 828, BLOOMFIELD HILLS, MI, 48303, US

(21) Appl. No.: 11/438,695

(22) Filed: May 22, 2006

(30) Foreign Application Priority Data
May 23, 2005 (JP) 2005-149103

(51) Int. Cl. B41J 29/38

(52) U.S. Cl. 347/17

(57) ABSTRACT

A droplet ejection apparatus includes a reservoir tank that retains liquid crystal, a substrate stage on which a mother substrate is mounted, and an ejection head that opposes the substrate stage. The ejection head and the stage are movable relative to each other. The ejection head includes a nozzle plate in which nozzles are defined. The ejection head pressurizes the liquid crystal supplied from the reservoir tank and thus ejects the liquid crystal from the nozzles onto the mother substrate. An ejection heat heater is provided around the ejection head for regulating the temperature of the liquid crystal. The ejection head heater has a projecting portion that projects from the nozzle plate toward the substrate stage. The projecting portion encompasses the nozzle plate. This maintains the viscosity of the liquid crystal in the vicinity of the nozzles at a sufficiently low level.

### CROSS-REFERENCE TO RELATED APPLICATION

This application is based upon and claims the benefit of priority from prior Japanese Patent Application No. 2005-149103, filed on May 23, 2005, the entire contents of which are incorporated herein by reference.

### BACKGROUND OF THE INVENTION

The present invention relates to a droplet ejection apparatus, an electro-optic panel, and an electronic device.

A droplet ejection method is known as a method for manufacturing a liquid crystal display. Specifically, a rectangular frame-like seal material is provided on a glass substrate. A necessary amount of liquid crystal for forming a liquid crystal layer is ejected onto an area defined by the seal material.

An inkjet method is known as this type of droplet ejection method. In the inkjet method, an ejection head including a plurality of nozzles is moved in a predetermined scanning direction while a glass substrate is transported in a sub scanning direction. In this state, liquid crystal retained in a reservoir tank is ejected onto the glass substrate through the nozzles. Since the size of a droplet of the ejected liquid crystal is extremely small in this method, the liquid crystal is adhered to the glass substrate in a closely packed state. This provides a liquid crystal layer with uniform thickness in a predetermined area defined by the seal material.

Generally, the liquid crystal exhibits relatively high viscosity, or, for example, approximately 50 to 100 cps at the room temperature. Thus, the liquid crystal cannot be converted into droplets in the atmosphere under the room temperature. Therefore, the reservoir tank is heated to decrease the viscosity of the liquid crystal. The liquid crystal is then pressurized in the ejection head and thus ejected from the nozzles. In this manner, the liquid crystal can be ejected as droplets (for example, see Japanese Laid-Open Patent Publication No. 2004-347695).

In the inkjet method, the ejection head includes a nozzle plate through which the nozzles are formed. The nozzle plate is arranged maximally close to the opposing surface of the glass substrate in order to allow the glass substrate to receive a droplet at an accurate position. This causes heat exchange between the liquid crystal in the vicinity of the nozzle openings and the glass substrate. Thus, for example, when the ejection head opposes a certain area of the glass substrate, the aforementioned heat exchange occurs. This lowers the temperature of the liquid crystal in the vicinity of the nozzle openings. Eventually, the difference between the temperature of the liquid crystal in the vicinity of the nozzle openings and the temperature of the glass substrate is canceled, thus raising the temperature of the liquid crystal in the vicinity of the nozzle openings. The raised temperature is maintained. However, when the ejection head is moved to a position opposed to another area of the glass substrate, the heat exchange occurs between the area and the liquid crystal in the vicinity of the nozzle openings. The temperature of the liquid crystal thus drops and then eventually rises. That is, as the ejection head is moved with respect to the glass substrate from one position to another to oppose a corresponding area of the glass substrate, the heat exchange occurs and varies the temperature of the liquid crystal in the vicinity of the nozzle openings. The viscosity of the liquid crystal is thus varied correspondingly, varying the ejection amount of the droplet of a single cycle of ejection. This makes it difficult to provide a liquid crystal layer with uniform thickness.

### SUMMARY

Accordingly, it is an objective of the present invention to provide a droplet ejection apparatus that accurately regulates an ejection amount of highly viscous liquefied material, an electro-optic panel manufactured using the droplet ejection apparatus, and an electronic device having the electro-optic panel.

To achieve the foregoing objectives and in accordance with one aspect of the present invention, a droplet ejection apparatus that ejects a liquefied material onto a target is provided. The apparatus includes a retainer chamber that retains the liquefied material, a stage on which the target is mounted, and an ejection head that opposes the stage. At least one of the ejection head and the stage is movable relative to the other. The ejection head includes a nozzle plate in which a nozzle is formed. The ejection head pressurizes the liquefied material supplied from the retainer chamber and thereby ejecting the liquefied material from the nozzle onto the target. The droplet ejection apparatus further includes a temperature regulating member provided around the ejection head for regulating the temperature of the liquefied material. The temperature regulating member has a projecting portion that projects from the nozzle plate toward the stage.

In accordance with another aspect of the present invention, an electro-optic panel manufactured using the above described droplet ejection apparatus is provided.

In accordance with a further aspect of the present invention, an electronic device having the above described electro-optic panel is provided.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view schematically showing a liquid crystal display according to an embodiment of the present invention;

FIG. 2 is a cross-sectional view schematically showing the liquid crystal display, taken along line 2-2 of FIG. 1;

FIG. 3 is a perspective view schematically showing a droplet ejection apparatus according to an embodiment of the present invention;

FIG. 4 is a cross-sectional view schematically showing the droplet ejection apparatus of FIG. 3;

FIG. 5 is a perspective view schematically showing a droplet ejection head provided in the droplet ejection apparatus of FIG. 3;

FIG. 6 is a cross-sectional view schematically showing the droplet ejection head, taken along line 6-6 of FIG. 5; and

FIG. 7 is a perspective view showing a liquid crystal television set having the liquid crystal display of FIG. 1.

### DETAILED DESCRIPTION OF THE PREFERRED EMBODIMENTS

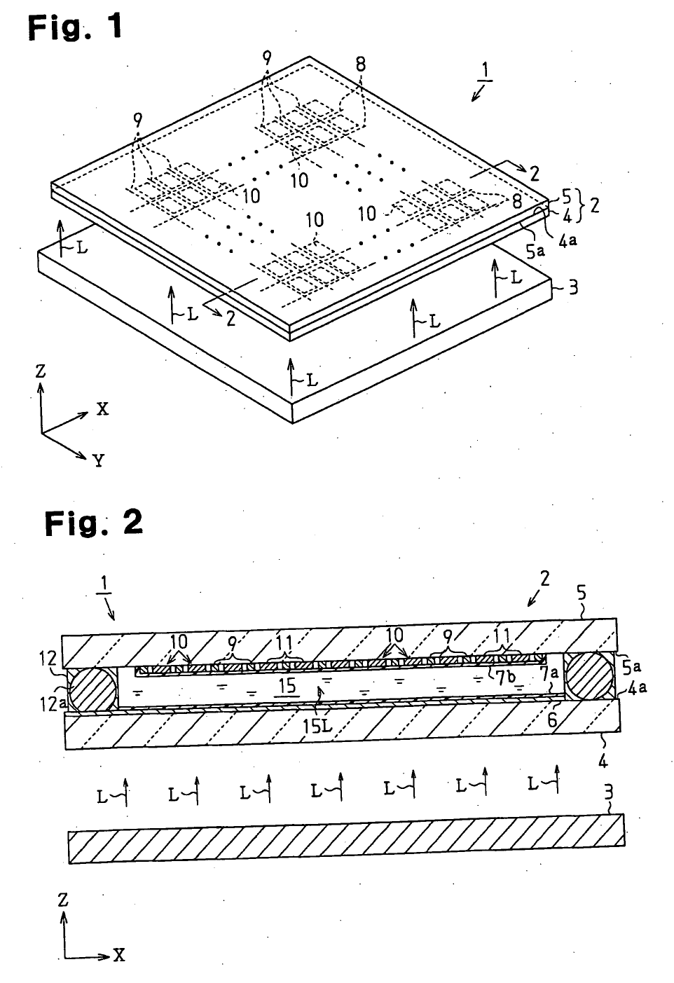

An embodiment of the present invention will now be described with reference to FIGS. 1 to 6.

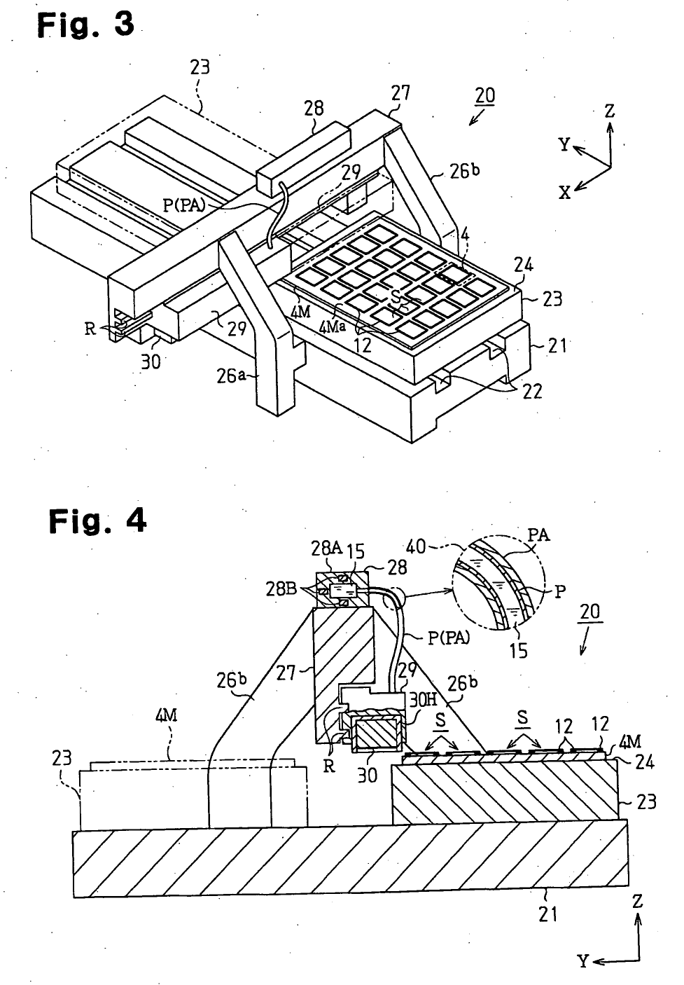

First, a liquid crystal display 1, which is manufactured using a droplet ejection apparatus 20 of FIG. 3, will be explained. As shown in FIG. 1, the liquid crystal display 1 has a liquid crystal panel 2, which is an electro-optic panel, and a radiation device 3. The radiation device 3 radiates light (area light) L onto the liquid crystal panel 2. Specifically, the light L radiated by the radiation device 3 onto the liquid crystal panel 2 proceeds in a direction perpendicular to a surface of the liquid crystal panel 2 (direction Z of FIG. 1). The liquid crystal panel 2 has an opposing substrate 4 and an element substrate 5 that are overlapped with each other. The opposing substrate 4 opposes the radiation device 3.

The opposing substrate 4 is a rectangular plate-like non-alkaline glass substrate. As shown in FIG. 2, the opposing substrate 4 has a surface opposing the element substrate 5, or an opposing electrode forming surface 4a. An opposing electrode 6 is formed on the opposing electrode forming surface 4a. The opposing electrode 6 is formed of, for example, an optically transparent conductive substance such as tin-indium oxide (ITO). The opposing electrode 6 is electrically connected to a non-illustrated power supply circuit. A predetermined level of common voltage is thus supplied from the power supply circuit to the opposing electrode 6. An alignment film 7a, which is subjected to an alignment process such as rubbing, is provided on the opposing electrode 6.

As shown in FIG. 1, the element substrate 5 is a rectangular plate-like non-alkaline glass substrate and sized substantially equal to the opposing substrate 4. The element substrate 5 has a surface opposing the opposing substrate 4, or an element forming surface 5a. A plurality of scanning lines 8, each of which extends in direction X of FIG. 1, are defined on the element forming surface 5a and spaced at predetermined pitches. Each of the scanning lines 8 is electrically connected to a non-illustrated scanning line driver circuit. Each scanning line 8 receives a corresponding scanning signal at a predetermined timing.

Also, a plurality of data lines 9, each of which extends in a direction perpendicular to the scanning lines 8 (direction Y of FIG. 1), are defined on the element forming surface 5a and spaced at predetermined pitches. Each of the data lines 9 is electrically connected to a non-illustrated data line driver circuit. Each data line 9 receives a data signal, which is generated from display data, at a timing determined in correspondence with the timing at which the scanning signal is sent to the corresponding scanning line 8.

A pixel area 10 is provided in the space defined by the corresponding ones of the scanning lines 8 and the crossing ones of the data lines 9. In other words, (n×m) pixel areas 10 are defined on the element substrate 5 in a matrix-like manner. A pixel electrode 11 (see FIG. 2) and a non-illustrated control element, which is formed by, for example, a thin film transistor (a TFT), is formed in each of the pixel areas 10. The pixel electrodes 11 are each formed of an optically transparent conductive substance such as tin-indium oxide (ITO). Each of the pixel electrodes 11 and the associated one of the control elements are connected to the corresponding one of the scanning lines 8 and the associated one of the data lines 9.

As illustrated in FIG. 2, an alignment film 7b, which is subjected to an alignment process such as rubbing, is provided on the layer including the data lines 9, the scanning lines 8, and the pixel electrodes 11. A seal material 12 having a spacer 12a is arranged between the element substrate 5 and the opposing substrate 4. The seal material 12 extends along the outer peripheries of the opposing substrate 4 and the element substrate 5 in such a manner as to define a rectangular frame. The seal material 12 spaces the element substrate 5 and the opposing substrate 4, or the element forming surface 5a and the opposing electrode forming surface 4a, from each other at a uniform distance corresponding to the outer diameter of the spacer 12a, which has a circular cross-sectional shape.

Thus, the seal material 12 defines a sealed space between the element substrate 5 and the opposing substrate 4, or the alignment film 7b and the alignment film 7a. In the sealed space, a liquid crystal layer 15L formed of liquid crystal 15, which is liquefied material retained in the sealed space, is provided.

As the scanning lines 8 are sequentially selected one by one by the scanning line driver circuit in accordance with the line progressive scan, the control elements of the corresponding pixel areas 10 are held in an ON state for a corresponding period. When one of the control elements is turned on, the data signal generated by the data line driver circuit is sent to the corresponding pixel electrode 11 through the data line 9 and the control element. Thus, the alignment state of the liquid crystal 15 is adjusted in correspondence with the difference between the potential of the pixel electrode 11 and the potential of the opposing electrode 6. This modulates the area light L radiated from the radiation device 3 onto the liquid crystal panel 2 in correspondence with the alignment state of the liquid crystal 15. Accordingly, through selective transmission of the modulated light L through a polarization plate (not shown), a desired image is displayed on the element substrate 5 of the liquid crystal panel 2.

The droplet ejection apparatus 20, which is used for manufacturing the above-described liquid crystal panel 2, will be explained in the following with reference to FIGS. 3 to 6.

As illustrated in FIGS. 3 and 4, the droplet ejection apparatus 20 ejects the liquid crystal 15 onto a single mother substrate 4M, thus providing a plurality of liquid crystal layers 15L. The mother substrate 4M is a base material from which a plurality of (in the illustrated embodiment, 25) opposing substrates 4 are produced. The mother substrate 4M, or an ejection object (a target), is a large-sized, rectangular non-alkaline glass substrate. Referring to FIG. 3, in each of the areas in which one of the opposing substrates 4 is to be formed, the opposing electrode 6 and the alignment film 7a (see FIG. 2) and the seal material 12 are formed in advance by a known method. For example, to form each of the seal materials 12, ultraviolet hardening resin in which the spacer 12a is dispersed is applied in a rectangular frame-like shape onto the outer periphery of the area in which the opposing substrate 4 is to be formed using a dispenser or through screen printing. Each of the substantially rectangular areas defined by the seal materials 12 corresponds to a formation area S in which the liquid crystal layer 15L is to be provided (see FIG. 3).

As shown in FIG. 3, the droplet ejection apparatus 20 includes a substantially parallelepiped base 21. A pair of guide grooves 22, extending in direction Y of FIG. 3, are formed in the upper surface of the base 21. The guide grooves 22 extend along the entire length of the base 21 in direction Y. A substrate stage 23, or a stage, is secured to the base 21 and operably connected to a non-illustrated Y-axis motor.

In response to a prescribed drive signal, the Y-axis motor rotates in a forward or reverse direction to move the substrate stage 23 forward or rearward in direction Y of FIG. 3 at a predetermined speed. In the illustrated embodiment, the position of the substrate stage 23 rightmost with respect to the base 21 as viewed in FIGS. 3 and 4 is defined as a proceed position (indicated by the corresponding solid lines). The position of the substrate stage 23 leftmost with respect to the base 21 as viewed in FIGS. 3 and 4 is defined as a return position (indicated by the double-dotted broken lines).

The upper surface of the substrate stage 23 forms a mounting surface 24 on which the mother substrate 4M is mounted. The mother substrate 4M is arranged on the mounting surface 24 with an ejection target surface 4Ma facing upward and positioned with respect to the substrate stage 23.

A pair of support members 26a, 26b are provided at opposing sides of the base 21 in direction X. A guide member 27, which extends in direction X, is supported by the support members 26a, 26b. A reservoir tank 28, which is a retainer chamber, is provided on the guide member 27.

As shown in FIG. 4, the reservoir tank 28 has a hollow box-like body 28A and reservoir tank heaters 28B, or retainer chamber heaters, which are embedded in walls that form the box-like body 28A. The box-like body 28A retains the liquid crystal 15. The viscosity of the liquid crystal 15 is higher at the room temperature but becomes lower as the temperature becomes higher. In other words, as the temperature becomes higher, the flowability of the liquid crystal 15 becomes higher. In the illustrated embodiment, the liquid crystal 15 exhibits the viscosity of, for example, 50 to 100 cps at the room temperature. However, at 60 degrees Centigrade, the viscosity of the liquid crystal 15 becomes sufficiently low for forming small droplets.

Each of the reservoir tank heaters 28B of the illustrated embodiment is a known elongated heat generating body and formed of, for example, silicon carbide (SiC). Each reservoir tank heater 28B is electrically connected to a non-illustrated power supply circuit and powered by the power supply circuit to generate heat. In the illustrated embodiment, the temperature of each reservoir tank heater 28B is regulated in such a manner that the liquid crystal 15 in the box-like body 28A is heated to 60 degrees Centigrade. This sufficiently lowers the viscosity of the liquid crystal 15 in the box-like body 28A and thus ensures sufficient flowability of the liquid crystal 15.

A tube P, which defines a passage, is connected to the reservoir tank 28. The tube P is flexible and communicates with an ejection head 30, which will be described later. The tube P supplies the liquid crystal 15 from the reservoir tank 28 to the ejection head 30.

The enlarged view encircled by circle 40 of FIG. 4 shows a cross section of the tube P. As shown in this view, a tape-like tube heater PA, or a passage heater, is wound around the entire circumference of the tube P. The tube heater PA is, for example, a flexible heat generating body such as a nichrome wire. The tube heater PA is electrically connected to the power supply circuit and powered by the power supply circuit to generate heat, thus heating the liquid crystal 15 through the tube P. In the illustrated embodiment, the temperature of the tube heater PA is regulated in such a manner as to heat the liquid crystal 15 flowing in the tube P to 60 degrees Centigrade. This maintains the viscosity of the liquid crystal 15 in the tube P at a sufficiently lowered level.

As shown in FIG. 3, a pair of guide rails R, extending in direction X, are arranged below the guide member 27 to cover the entire guide member 27 in the longitudinal direction of the guide member 27. A carriage 29 is secured to the guide rails R. The carriage 29 is operably connected to an X-axis motor (not shown) and thus linearly moves selectively in direction X and the direction opposite to direction X. The width of the carriage 29 in direction X is substantially equal to the width of the mother substrate 4M (the ejection target surface 4Ma) in direction X. In response to a prescribed drive signal, the X-axis motor rotates in a forward or reverse direction to move the carriage 29 forward or rearward in direction X. In the illustrated embodiment, the position of the carriage 29 leftmost with respect to the guide member 27 as viewed in FIG. 3 is defined as a proceed position (indicated by the corresponding solid lines). The position of the carriage 29 rightmost with respect to the guide member 27 as viewed in FIG. 3 is defined as a return position (indicated by the double-dotted broken lines).

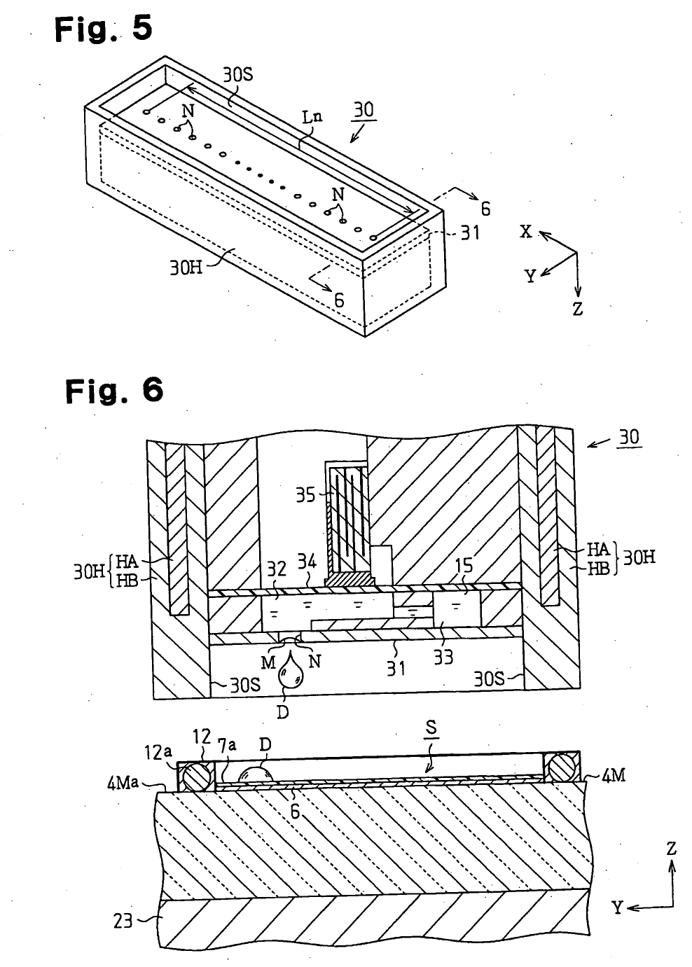

The droplet ejection head (hereinafter, referred to simply as an “ejection head”) 30 is arranged in a lower portion of the carriage 29. FIG. 5 shows the ejection head 30 as viewed from below (from the side corresponding to the substrate stage 23). The surface of the ejection head 30 facing upward in FIG. 5 thus opposes the mother substrate 4M. Referring to FIG. 5, the ejection head 30 has a nozzle plate 31 formed on the lower surface of the ejection head 30, which is the surface opposing the mother substrate 4M. A plurality of ejection nozzles (hereinafter, referred to simply as “nozzles”) N are provided in the lower surface of the nozzle plate 31 and extend through the nozzle plate 31 in direction Z. The nozzles are aligned along a single line in direction X. In the illustrated embodiment, the length Ln of the line of the nozzles N, which are aligned in direction X, is substantially equal to the width of the mother substrate 4M in direction X.

With reference to FIG. 6, the ejection head 30 includes a plurality of cavities 32 (only one is shown in the drawing) in correspondence with the nozzles N. The cavities 32 communicate with a common supply line 33. The supply line 33 is connected to the tube P (see FIG. 4) in such a manner that the liquid crystal 15 is supplied from the reservoir tank 28 to the supply line 33. As has been described, the tube P is heated by the tube heater PA. Thus, the viscosity of the liquid crystal 15 supplied to the supply line 33 through the tube P is held in a lowered state.

An oscillation plate 34 is arranged above each of the cavities 32. A plurality of piezoelectric elements 35 are also provided above the cavities 32 in correspondence with the cavities 32. In response to a drive signal for driving each of the piezoelectric elements 35, the piezoelectric element 35 extends and contracts in a vertical direction (along direction Z), thus oscillating the oscillation plate 34 in the vertical direction (along direction Z). This increases and decreases the volume of the corresponding cavity 32 and thus pressurizes the liquid crystal 15 in the cavity 32.

As shown in FIG. 5, an ejection head heater 30H, which encompasses the nozzle plate 31, is provided along the outer circumference of the ejection head 30. Referring to FIG. 6, the ejection head heater 30H, which functions as a temperature regulating member and a heater, includes a heat generating member HA and a thermal insulating member HB. The thermal insulating member HB encompasses the heat generating member HA.

In the illustrated embodiment, the heat generating member HA includes a plurality of known elongated heat generating bodies and formed of, for example, silicon carbide (SiC). The heat generating member HA is electrically connected to the power supply circuit and powered by the power supply circuit to generate heat. The heat insulating member HB transmits the heat generated by the heat generating member HA uniformly to the liquid crystal 15 in the ejection head 30. Meanwhile, the heat insulating member HB functions to insulate the ejection head 30 to prevent the heat of the liquid crystal 15 from escaping to the exterior. By heating the liquid crystal 15 in the cavities 32, the ejection head heater 30H sufficiently lowers the viscosity of the liquid crystal 15 in the vicinity of the nozzles N.

As shown in FIG. 6, the ejection head heater 30H has a portion (an extended portion) extended downward from the nozzle plate 31 (toward the substrate stage 23), or, in other words, a portion (a projecting portion) 30S projecting downward from the nozzle plate 31 (toward the substrate stage 23). The projecting portion 30S encompasses the nozzle plate 31 and is located closer to the mother substrate 4M than the nozzle plate 31.

A method for manufacturing the liquid crystal display 1 using the droplet ejection apparatus 20 will hereafter be explained.

First, as illustrated in FIG. 3, the mother substrate 4M is placed on and fixed to the substrate stage 23 that is located at the proceed position (as indicated by the corresponding solid lines of the drawing), with the ejection target surface 4Ma facing upward. In this state, the mother substrate 4M (the ejection target surface 4Ma) is located offset from the position opposing the guide member 27.

Meanwhile, the power supply circuit is activated to supply power to the reservoir tank heaters 28B, the tube heater PA, and the heat generating member HA. This heats the liquid crystal 15 in each of the reservoir tank 28, the tube P, and the ejection head 30. The liquid crystal 15 thus becomes flowable.

Subsequently, the X-axis motor is actuated to move the carriage 29 from the proceed position (as indicated by the corresponding solid lines of FIG. 3) in the direction opposite to direction X in such a manner as to arrange the ejection head 30 at a position corresponding to the substrate stage 23 (the mother substrate 4M) in direction X. In this state, the Y-axis motor is activated to move the substrate stage 23 (the mother substrate 4M) in direction Y.

As the substrate stage 23 moves, the nozzles N of the ejection head 30 reach the positions opposing a corresponding line of the forming areas S that are aligned on the mother substrate 4M in direction X. In this state, heat exchange occurs between the ejection head 30 and the mother substrate 4M that mutually oppose and are arranged close to each other through the atmospheric air. However, the ejection head heater 30H has the projecting portion 30S that projects from the nozzle plate 31 toward the substrate stage 23. The projecting portion 30S encompasses the nozzle plate 31, thus preventing the heat in the vicinity of the nozzle plate 31 from escaping to the exterior. This suppresses variation of the temperature of the nozzle plate 31 and maintains the temperature of the nozzle plate 31 at approximately 60 degrees Centigrade.

When the nozzles N of the ejection head 30 oppose the line of the corresponding forming areas S, the piezoelectric elements 35 corresponding to the nozzles N each receive a drive signal. Each of the piezoelectric elements 35 thus extends and contracts and the corresponding one of the cavities 32 is depressurized and pressurized. This oscillates the interface (the meniscus M) of the liquid crystal 15 in each nozzle N in direction Z and the direction opposite to direction Z. At this stage, since the viscosity of the liquid crystal 15 has been sufficiently lowered through heating, the liquid crystal 15 is sufficiently flowable. Accordingly, the liquid crystal 15 is ejected from the nozzles N onto the forming areas S as small droplets D, which are then adhered to the corresponding forming areas S.

Afterwards, transportation of the substrate stage 23 in direction Y and ejection of the droplets D from the nozzles N are repeated in the same manner as the above-described manner. In this manner, a predetermined amount of the liquid crystal 15 is ejected onto all of the forming areas S defined on the mother substrate 4M.

Accordingly, the mother substrate 4M has twenty five forming areas S to which the predetermined amount of the liquid crystal 15 is adhered. Another mother substrate (not shown), or a base material from which twenty five element substrates 5 are obtained, is then bonded with the mother substrate 4M. The bonded product is then subjected to dicing, thus forming twenty five liquid crystal panels 2. Subsequently, the radiation device 3 is secured to each of the liquid crystal panels 2 to complete the liquid crystal display 1.

The illustrated embodiment has the following advantages.

(1) In the illustrated embodiment, the ejection head heater 30H is provided along the outer circumference of the ejection head 30 to encompass the nozzle plate 31. This maintains the viscosity of the liquid crystal 15 in the vicinity of the nozzles N at a sufficiently low level.

(2) The ejection head heater 30H includes the projecting portion 30S that projects from the nozzle plate 31 toward the substrate stage 23. The projecting portion 30S encompasses the nozzle plate 31. The heat in the vicinity of the nozzle plate 31 is thus prevented from escaping to the exterior. This suppresses variation of the temperature of the nozzle plate 31, or variation of the temperature of the liquid crystal 15 in the vicinity of the nozzles N. The temperature of the liquid crystal 15 is thus maintained at approximately 60 degrees Centigrade. This maintains the viscosity of the liquid crystal 15 in the vicinity of the nozzles N at a sufficiently lowered level. The ejection amount of each droplet D of the liquid crystal 15 is thus accurately adjusted. This provides the liquid crystal layer 15L having uniform thickness, and the liquid crystal display 1 exhibiting improved display quality can be obtained.

(3) The reservoir tank heaters 28B are embedded in the walls of the reservoir tank 28, which retains the liquid crystal 15. Each reservoir tank heater 28B heats the liquid crystal 15 in the reservoir tank 28 in such a manner as to sufficiently lower the viscosity of the liquid crystal 15. Thus, by retaining a sufficient amount of liquid crystal 15 in the reservoir tank 28, the liquid crystal 15 having decreased viscosity and increased flowability can be supplied to the ejection head 30 in a constantly stable manner.

(4) The tape-like tube heater PA is provided around the entire circumference of the tube P, which extends between the reservoir tank 28 and the ejection head 30. The tube heater PA heats the liquid crystal 15 in the tube P to sufficiently decrease the viscosity of the liquid crystal 15. The liquid crystal 15 thus smoothly flows from the reservoir tank 28 to the ejection head 30. This ensures supply of the liquid crystal 15 with lowered viscosity and improved flowability to the ejection head 30.

Next, application of the liquid crystal display 1 to an electronic device will be explained. The liquid crystal display 1 may be applied to different types of electronic devices such as a mobile personal computer, a mobile telephone, and a digital camera. It is to be understood that the liquid crystal display 1 may be applied to not only a relatively small-sized electronic device such as a mobile electronic device but also a relatively large-sized electronic device.

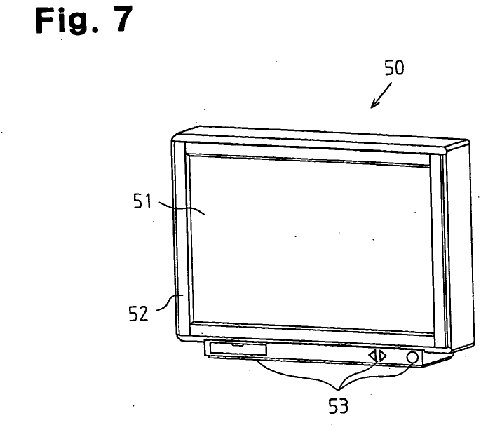

FIG. 7 is a perspective view showing a liquid crystal television set 50 having the liquid crystal display 1. The liquid crystal television set 50 includes a display unit 51 having the liquid crystal display 1 for a large-sized television set and a plurality of manipulation buttons 53. The display unit 51, which includes the liquid crystal display 1 that has been manufactured in the above-described manner, has the liquid crystal layer 15L having uniform thickness (see FIG. 1). An improved image is thus displayed by the display unit 51 without causing variation in brightness.

The illustrated embodiment may be modified as follows.

In the illustrated embodiment, the liquid crystal layer 15L of the liquid crystal display 1 is formed using the droplet ejection apparatus 20. However, the droplet ejection apparatus 20 may be employed for forming a conductive layer including the scanning lines 8 and the data lines 9 or an insulating layer. That is, any suitable component may be formed using the droplet ejection apparatus 20 of the illustrated embodiment as long as the component can be formed through ejection of droplets of highly viscous liquefied material under the room temperature.

In the illustrated embodiment, each of the reservoir tank 28, the tube P, and the ejection head 30 includes the corresponding heater(s), or the reservoir tank heaters 28B, the tube heater PA, and the heat generating member HA, respectively. However, only the reservoir tank 28 may include the heaters 28B. This simplifies the structure of the liquid crystal display 1.

In the illustrated embodiment, the reservoir tank 28, the tube P, and the ejection head all have the corresponding heaters 28B, PA, and 30H. However, a temperature regulating member that selectively heats and cools the liquid crystal 15 may be provided in each of the reservoir tank 28, the tube P, and the ejection head 30. This ensures further accurate regulation of the temperature of the liquid crystal 15.

The liquid crystal 15 may be heated to different temperatures in the reservoir tank 28, the tube P, and the ejection head 30. For example, the power supplied to the reservoir tank heater 28B, the tube heater PA, and the heat generating member HA may be adjusted in such a manner that the temperature of the liquid crystal 15 becomes lower in the order of the reservoir tank 28, the tube P, and the ejection head 30. In this case, the power supplied to the heat generating member HA needs to be sufficiently great for ensuring sufficient flowability of the liquid crystal 15 in the ejection head 30.

In the illustrated embodiment, the seal materials 12 (the forming areas S) are arranged in the mother substrate 4M from which the opposing substrates 4 are obtained. The droplets D of the liquid crystal 15 are thus ejected onto the mother substrate 4M. However, the seal materials 12 (the forming areas S) may be provided in the mother substrate from which the element substrates 5 are formed. In this case, the droplets D of the liquid crystal 15 are ejected onto this mother substrate for forming the element substrates 5.

In the illustrated embodiment, the piezoelectric elements 35 are each employed as an ejecting portion that ejects the liquid crystal 15. However, for example, a resistance heating element may be employed as the ejecting portion. The resistance heating element generates bubbles in each cavity 32 through heating and the bubbles pressurize the interior of the cavity 32. Alternatively, the ejecting portion may be formed by a pressurization pump that pressurizes air supplied to a dispenser. In this case, the liquid crystal 15 (the liquefied material) is ejected through pressurization.

In the illustrated embodiment, each of the nozzles N of the droplet ejection head 30 forms a liquid crystal ejection port. However, the liquid crystal ejection port may be formed by an ejection nozzle of an air type dispenser.

In the illustrated embodiment, the liquid crystal 15 is (the droplets D are) ejected onto the multiple forming areas S on the mother substrate 4M from which the opposing substrates 4 are produced. However, the droplet D may be ejected onto a substrate (an opposing substrate 4) having a single forming area S.

In the illustrated embodiment, the liquid crystal display 1 is formed by the droplet ejection apparatus 20 that ejects the liquid crystal as the liquefied material. However, different types of metal wirings of the liquid crystal display 1 or other types of displays may be formed using a droplet ejection apparatus that ejects metal ink as the liquefied material. These displays include a display with a field effect type device (an FED or an SED) that has a flat electron emission element. The field effect type device radiates electrons emitted by the electron emission element onto a fluorescent substance, thus emitting light from the fluorescent substance.

Although the multiple embodiments have been described herein, it will be clear to those skilled in the art that the present invention may be embodied in different specific forms without departing from the spirit of the invention. The invention is not to be limited to the details given herein, but may be modified within the scope and equivalence of the appended claims.

1. A droplet ejection apparatus that ejects a liquefied material onto a target, the apparatus comprising:
a retainer chamber that retains the liquefied material;
a stage on which the target is mounted;
an ejection head that opposes the stage, wherein at least one of the ejection head and the stage is movable relative to the other, the ejection head including a nozzle plate in which a nozzle is formed, the ejection head pressurizing the liquefied material supplied from the retainer chamber and thereby ejecting the liquefied material from the nozzle onto the target; and
a temperature regulating member provided around the ejection head for regulating the temperature of the liquefied material, the temperature regulating member having a projecting portion that projects from the nozzle plate toward the stage.

2. The droplet ejection apparatus according to claim 1, wherein the temperature regulating member includes a heater.

3. The droplet ejection apparatus according to claim 1, wherein the projecting portion encompasses the nozzle plate.

4. The droplet ejection apparatus according to claim 1, wherein the retainer chamber has a heater that heats the liquefied material.

5. The droplet ejection apparatus according to claim 1, further comprising a passage through which the liquefied material flows from the retainer chamber to the ejection head, wherein the passage includes a heater that heats the liquefied material flowing in the passage.

6. The droplet ejection apparatus according to claim 1, wherein the liquefied material is a liquid crystal.

7. An electro-optic panel manufactured using the droplet ejection apparatus according to claim 1.

8. An electronic device having the electro-optic panel according to claim 7.
